(19) United States
(12) Patent Application Publication
(10) Pub. No.: US 2018/0027751 A1
(43) Pub. Date: Feb. 1, 2018

(54) PLANT HOLDER FOR GROWING PLANTS

(71) Applicant: David Willingham, Grants Pass, OR (US)

(72) Inventor: David Willingham, Grants Pass, OR (US)

(21) Appl. No.: 15/351,946

(22) Filed: Nov. 15, 2016

Related U.S. Application Data
(60) Provisional application No. 62/369,186, filed on Jul. 31, 2016.

(51) Int. Cl. A01G 9/02; A01G 9/10

(52) U.S. Cl. CPC A01G 9/024; A01G 9/1086; A01G 9/1073

(57) ABSTRACT

A stackable plant holder for growing one or more plants is provided. The stackable plant holder includes: (i) a plant box, (ii) a vent, and (iii) an adjustable hanger. The plant box is filled with soil. The vent is adapted to drain an excess of water into a gutter. The vent is provided at the bottom of the plant box. The adjustable hanger is adapted to be coupled to backside of the plant box to hang the plant box.

### BACKGROUND

### Technical Field

This application claims priority to and the benefits of the provisional patent application No. “62/369,186” titled “A PLANT HOLDER FOR GROWING PLANTS” filed in United States Patent and Trademark Office on “Jul. 31, 2016”.

The embodiments herein generally relate to a holder and more particularly, a plant holder for growing various plants.

### Description of the Related Art

Plants and flowers are sold everywhere at huge amounts. The plants and flowers are cut and arranged in different arrangements and sold in market. After cutting the plants from stem, the plants have no roots. The life of the plants having no roots is less as compared to the plants having the roots. Maintaining freshness of the plants or flowers with no roots for longer period is a challenging process.

Pots are effective way to keep the plants alive for longer period, as in pots there is no need to cut the roots from the plants. Pots are easy to handle and to water the plants on regular basis. However, the commercially available pots acquire huge space for growing the plants.

The present invention provides an alternate solution to the above mentioned problems by providing a plant holder with an adjustable hanger.

### SUMMARY

In view of the foregoing, an embodiment herein provides a plant holder for growing one or more plants. The plant holder includes: (i) a plant box, (ii) a vent, (iii) an adjustable hanger, and (iv) a gutter. The plant box is filled with soil. The vent is provided at the bottom of the plant box. The adjustable hanger is adapted to be coupled to backside of the plant box to hang the plant box. The gutter is adapted to hold an excess of water.

In one embodiment, the plant box is in a trapezoidal shape. In another embodiment, the plant holder is made from plastic and is stackable. In another embodiment, the vent is adapted to drain the excess of water into the gutter.

In yet another aspect of the present invention, a stackable plant holder for growing one or more plants is provided. The stackable plant holder includes: (i) a plant box, (ii) a vent, and (iii) an adjustable hanger. The plant box is filled with soil. The vent is adapted to drain an excess of water into a gutter. The vent is provided at the bottom of the plant box. The adjustable hanger is adapted to be coupled to backside of the plant box to hang the plant box.

In one embodiment, the plant box is in a trapezoidal shape. In another embodiment, the stackable plant holder is made from plastic.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof and the embodiments herein include all such modifications.

### BRIEF DESCRIPTION OF THE DRAWINGS

The embodiments herein will be better understood from the following detailed description with reference to the drawings, in which:

FIG. 1 illustrates a cut-section view of a plant holder for growing plants according to an embodiment herein;

FIGS. 2A, 2B, 2C, and 2D illustrate an exploded view 200 of the plant holder of FIG. 1 according to an embodiment herein; and

FIG. 3 shows the perspective view 300 of the plant holder for growing plants according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

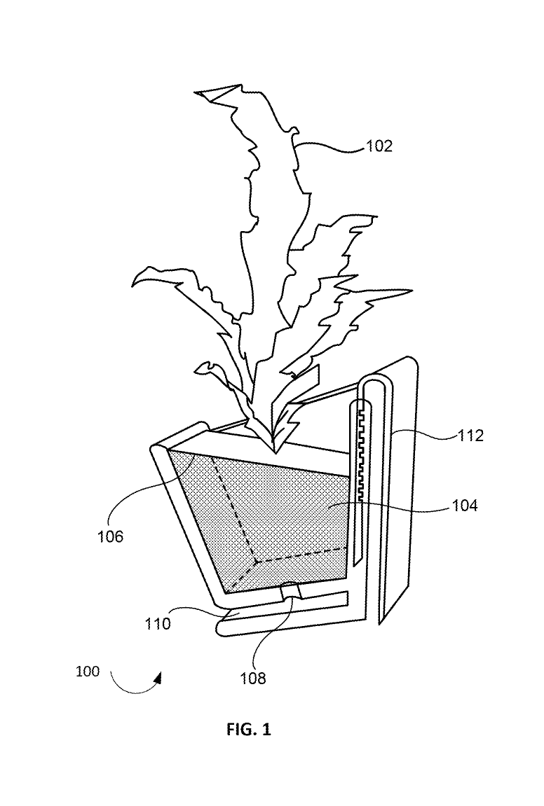

As mentioned, there remains a need for a simple, inexpensive and easy to adjust, plant holder for growing plants at a less spacious area. The embodiments herein achieve this by providing a plant holder for growing plants. Referring now to the drawings, and more particularly to FIGS. 1 through 3, where similar reference characters denote corresponding features consistently throughout the figures, there are shown preferred embodiments.

FIG. 1 illustrates a cut-section view of a plant holder 100 for growing plants according to an embodiment herein. The plant holder 100 includes one or more plants 102, soil 104, a plant box 106, a vent 108, a gutter 110, and an adjustable hanger 112. The soil 104 is filled in the plant box 106, and the one or more plants 102 are planted in the soil 104. The vent 108 is a small hole in the lower side of the plant box 106 that drains excessive water into the gutter 110. The gutter 110 is a passage that drains the excessive water from the vent 108. The adjustable hanger 112 is coupled to the plant box 106. The adjustable hanger 112 is adapted to hang the plant box 106. In one embodiment, one or more plant holders are connected horizontally and/or vertically.

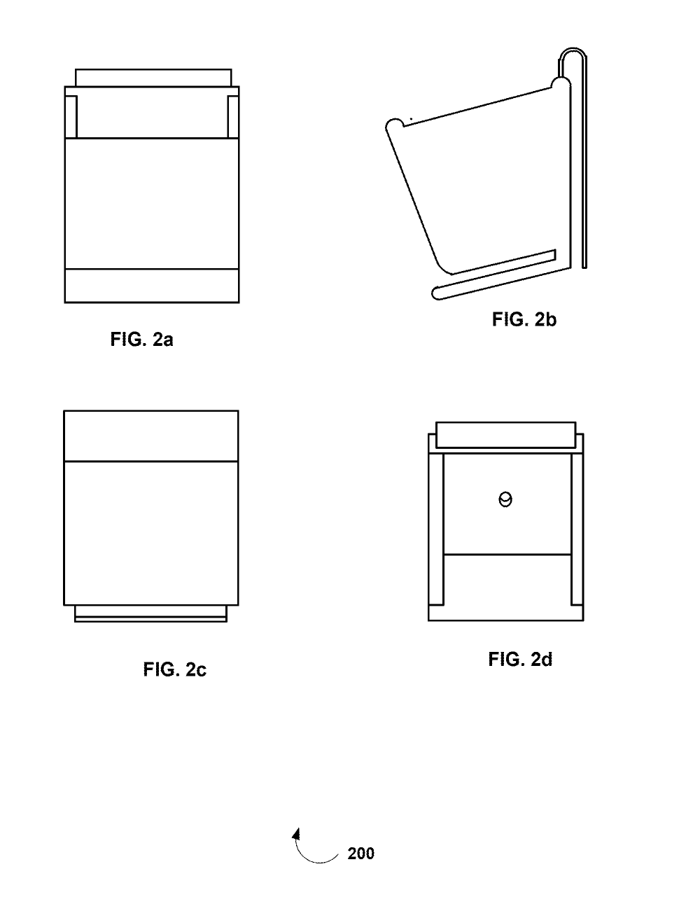

FIGS. 2A, 2B, 2C, and 2D illustrate an exploded view 200 of the plant holder 100 of FIG. 1 according to an embodiment herein. The exploded view 200 includes a front view of the plant holder 100, a left side view of the plant holder 100, a bottom view of the plant holder 100, and a top view of the plant holder 100. In one embodiment, the material of the plant holder is selected from a group including, but not limiting to: (i) plastic, (ii) steel, (iii) ceramic and/or mixture thereof

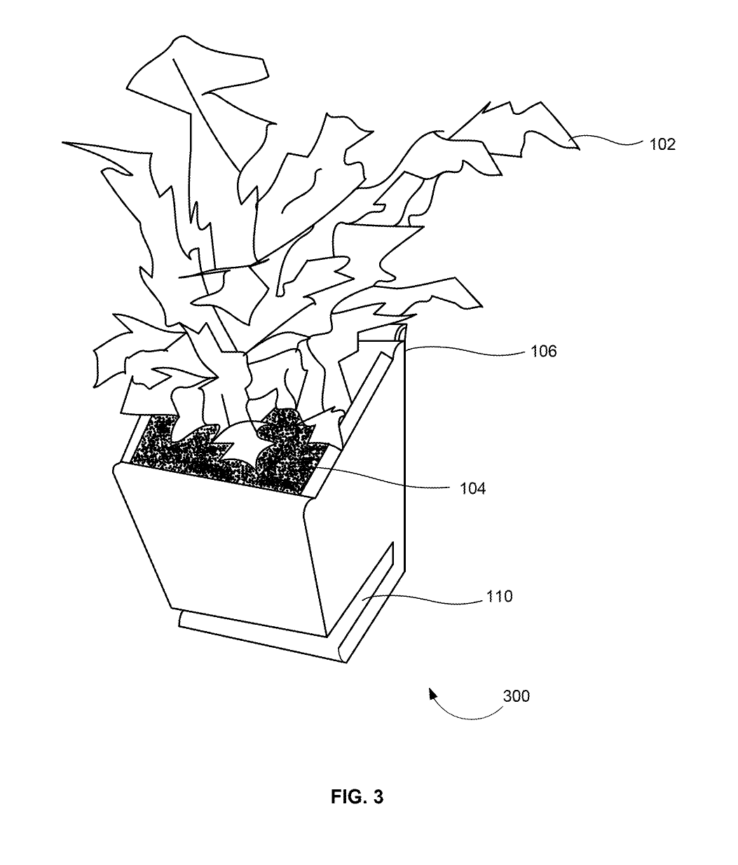

FIG. 3 shows the perspective view 300 of the plant holder for growing plants according to an embodiment herein. In one embodiment, the adjustable hanger 112 is provided on the backside of the plant box 106 to fix the plant holder 100 to any shaped wood fences, railings, and chain link fences or the like.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A plant holder for growing one or more plants, wherein said plant holder comprises:
a plant box, wherein said plant box is filled with soil;
a vent, wherein said vent is provided at the bottom of said plant box;
an adjustable hanger that is adapted to be coupled to backside of said plant box to hang said plant box; and
a gutter, wherein said gutter is adapted to hold an excess of water.

2. The plant holder of claim 1, wherein said plant box is in a trapezoidal shape.

3. The plant holder of claim 1, wherein said plant holder is made from plastic.

4. The plant holder of claim 1, wherein said plant holder is stackable.

5. The plant holder of claim 1, wherein said vent is adapted to drain said excess of water into said gutter.

6. A stackable plant holder for growing one or more plants, wherein said stackable plant holder comprises:
a plant box, wherein said plant box is filled with soil;
a vent that is adapted to drain an excess of water into a gutter, wherein said vent is provided at the bottom of said plant box; and
an adjustable hanger that is adapted to be coupled to backside of said plant box to hang said plant box.

7. The stackable plant holder of claim 6, wherein said plant box is in a trapezoidal shape.

8. The stackable plant holder of claim 6, wherein said stackable plant holder is made from plastic.
